(19) United States
(12) Patent Application Publication
(10) Pub. No.: US 2019/0050945 A1
(43) Pub. Date: Feb. 14, 2019

(54) AUTO-SUGGESTION FOR GROUP ACTIVITIES BASED ON COMBINED USER DATA SETS

(71) Applicant: Microsoft Technology Licensing, LLC, Redmond, WA (US)

(72) Inventors: Marcus Alan ASH, Renton, WA (US); Steve SEIXEIRO, Snohomish, WA (US); Lijuan QIN, Redmond, WA (US); George Fitzgerald MATTHEWS, Boston, MA (US); Gurpreet VIRDI, Redmond, WA (US)

(21) Appl. No.: 15/675,986

(22) Filed: Aug. 14, 2017

(51) Int. Cl. G06Q 50/00; H04L 29/08; G06F 17/30

(52) U.S. Cl. CPC G06Q 50/01; H04L 67/22; G06F 17/30958; G06F 17/30029; H04L 67/306

(57) ABSTRACT

An event service is configured to create groups of computing device users proactively and intelligently based on analyses of user data sets of group members that describe location, availability, social graphs, and interests. The event service is further configured to identify events and activities by analyzing data acquired from web-based and external resources such as third-party databases and large data sets, and obtain marketing information including discounts, coupons, and other promotions that are pertinent to a given event. Utilizing the user data sets from the combined group, the event service can make suggestions for group activities at suitable times and location to enable the members to discover and participate in activities with other members of the group that are relevant and interesting while taking advantage of available promotions.

### BACKGROUND

Social networks enable computing device users to interact with friends, colleagues, family members, and other people to stay connected and informed. Users may participate in events, activities, and gatherings with the people with whom they are connected within their social graph.

### SUMMARY

An event service is configured to create groups of computing device users proactively and intelligently based on analyses of user data sets of group members that describe location, availability, social graphs, and interests. For example, signals from the computing device can be monitored to identify location from a suitable device sensor, availability from a calendar application on the device, social graph from social networking application, and interests from profile information, interactions with a digital assistant, web browsing history, and other contextual information. The event service is further configured to identify events and activities by analyzing data acquired from web-based and external resources such as third-party databases and large data sets, and obtain marketing information including discounts, coupons, and other promotions that are pertinent to a given event. Utilizing the user data sets from the combined group, the event service can make suggestions for group activities at suitable times and locations to enable the members to discover and participate in activities with other members of the group that are relevant and interesting while taking advantage of available promotions.

In various illustrative embodiments of auto-suggestion for group activities, the event service can utilize data mining techniques to collect data that is descriptive of the user's social graph from one or multiple social networks (where the data collection is performed with notice to the user and user consent) when creating a group. The event service may analyze the collected descriptive data to identify connections, groups, associations, and other information. The analysis and identification may be performed using implicit inferences (e.g., to infer user interests based on associations) or using explicit information (e.g., to identify direct connections among users or groups). The event service may also build and utilize a trustable social graph using the descriptive data from one or multiple social networks.

The event service can use the descriptive data to identify and form groups such as sports teams, office colleagues, club members, family members and the like. However, the groups do not have to be permanent, formal groups. Ad-hoc, one-off groups can also be supported by the event service. For example, a group can be a college football team with a full schedule of practices and games, an active family of four, or two friends meeting at a downtown coffee shop in the afternoon. The event service can provide suggestions for group activities to all of the members of a group (e.g., a user's entire karate class), or portions of a group based on the data sets associated with each member (e.g., only members of the karate class who enjoy comedy movies).

The event service enables users to save time by reducing the effort that is typically needed to plan and contact groups members when organizing a group activity. The event service also leverages the collected user data sets and large data sets to intelligently identify and suggest group activities that have increased likelihood of being relevant to the group while providing good value through the linkage to available promotions. The event service can further improve operations on the computing device by preserving device resources such as battery power, bandwidth, cellular data, cellular phone minutes, and text messaging limits as users do not need to spend time browsing the web for activities, collaborating with friends to set up an event, or combing through potential events to identify activities that are commonly liked and for which people are available to attend.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows an illustrative environment in which an event service interacts with various users, social graphs, and third-party data;

FIG. 2 depicts various forms of data that are received by the event service to perform a variety of functions;

FIG. 3 shows illustrative examples of social graph data;

FIG. 4 shows illustrative context data that may be associated with the user or the user's computing device;

FIG. 5 shows illustrative event criteria that may be associated with a given event;

FIG. 6 shows illustrative available activities based on an overlap between the identified context data, activities, and social graph;

FIG. 7A shows illustrative corresponding context data between users;

FIG. 7B shows illustrative examples of the corresponding context data;

FIGS. 8A-B show illustrative available activities based on a comparison between context data and event criteria;

FIG. 9 shows an illustrative environment in which the event service transmits the event suggestions to users within a group;

FIG. 10 shows an illustrative environment in which event suggestions are transmitted to multiple different groups within a social graph;

FIG. 11 shows an illustrative graphical user interface (GUI) in which the user can select activities to accept or deny;

FIG. 12 shows an illustrative taxonomy of actions that cause a dismissal of event suggestions;

FIG. 13 shows an illustrative interaction between the user and a digital assistant in which the event service proactively provides suggestions;

FIG. 14 shows an illustrative interaction between the user and a digital assistant in which the event service reactively provides suggestions;

FIGS. 15-17 show illustrative methods performed by the event service;

FIG. 18 is a simplified block diagram of an illustrative computer system such as a personal computer (PC) that may be used in part to implement the present auto-suggestion for group activities based on combined user data sets; and

FIG. 19 shows a block diagram of an illustrative device that may be used in part to implement the auto-suggestion for group activities based on combined user data sets.

Like reference numerals indicate like elements in the drawings. Elements are not drawn to scale unless otherwise indicated.

### DETAILED DESCRIPTION

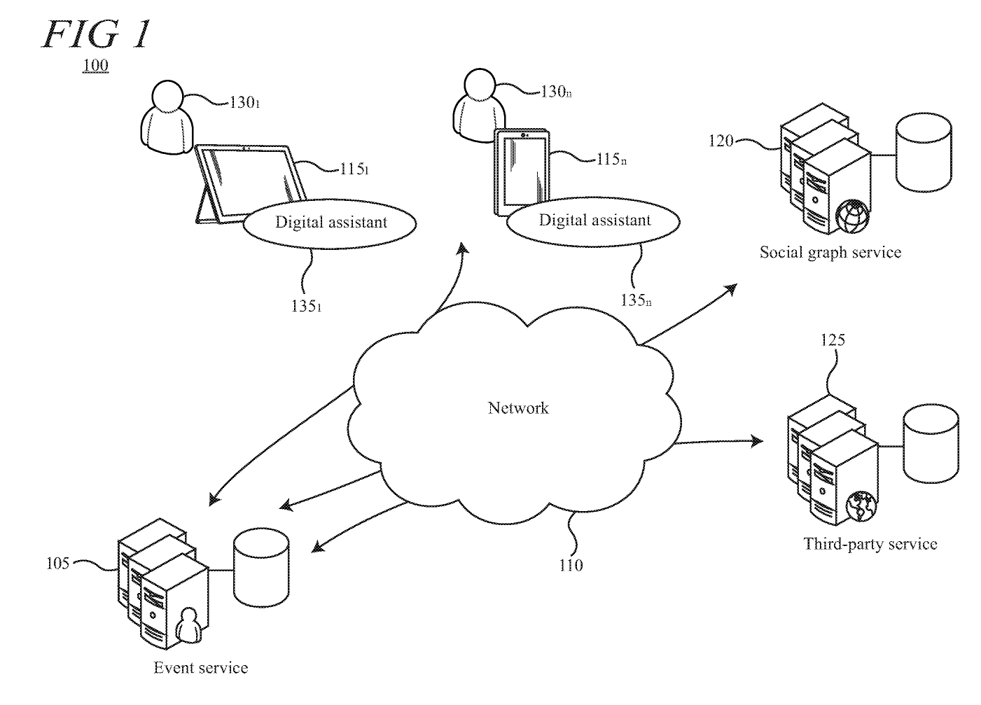

FIG. 1 shows an illustrative environment 100 in which an event service 105 instantiated on one or more servers interacts over a network 110 with devices 115, social graph service 120, and third-party service 125. The number of devices, servers, and services depicted in FIG. 1 is one exemplary embodiment and additional devices and servers may also be implemented.

The social graph service 120 can be based on a social network that users 130 utilize for personal or professional use. For example, the social networks can be a professional network to connect with colleagues, a personal network to connect with current friends, past friends, acquaintances, and family, or a combination of the two. The third-party service 125, as discussed in further detail below, can be associated with and store information about planned events, such as sporting events, concerts, or hours of operation for a restaurant, coffee shop, etc. The third-party service may directly store event information and may be dedicated to a particular cause (e.g., sporting events) or indirectly store event information, such as information obtained via crawling the World Wide Web.

The devices 115 operated by users 130 can include any number of computing devices beyond the smartphone and tablet devices depicted in FIG. 1. For example, other devices can include a game console, laptop computer, personal computer (PC), television (e.g., smart television), and wearable devices such as a wearable watch or head-mounted display. These devices 115 can support telephony capabilities (e.g., voice and/or video, text, or chat) and typically support data-consuming applications such as Internet browsing and multimedia (e.g., music, video, etc.) consumption in addition to various other features. These devices may be used by users to make and receive voice and/or video calls (individually and collectively referred to as “calls”), share multimedia, engage in messaging (e.g., texting) and e-mail communications, use applications, and access services that employ data, browse the World Wide Web, and the like.

A virtual digital assistant 135 can be instantiated on the devices 115, such as at an operating system (OS) layer of the device's architecture, which interoperates with an application layer. The digital assistant can perform various tasks automatically or responsively to user interactions, such as voice, touch, or gesture-based user interactions. The digital assistant can be configured to respond to user queries (e.g., what is the weather, who won the sporting event last night, etc.), gather information, set reminders, set calendar appointments, send messages, etc. Although the digital assistant is depicted as being instantiated on the devices 115, the digital assistant may operate with a remote digital assistant service as well (not shown).

The interactions depicted by the arrows in FIG. 1 can occur over the network 110, which can include a series of interconnected devices, modems, switches, and the like. For example, the network can include any environment that connects devices at nodes of a network, such as a personal area network (PAN), local area network (LAN), wide area network (WAN), the Internet, World Wide Web, etc.

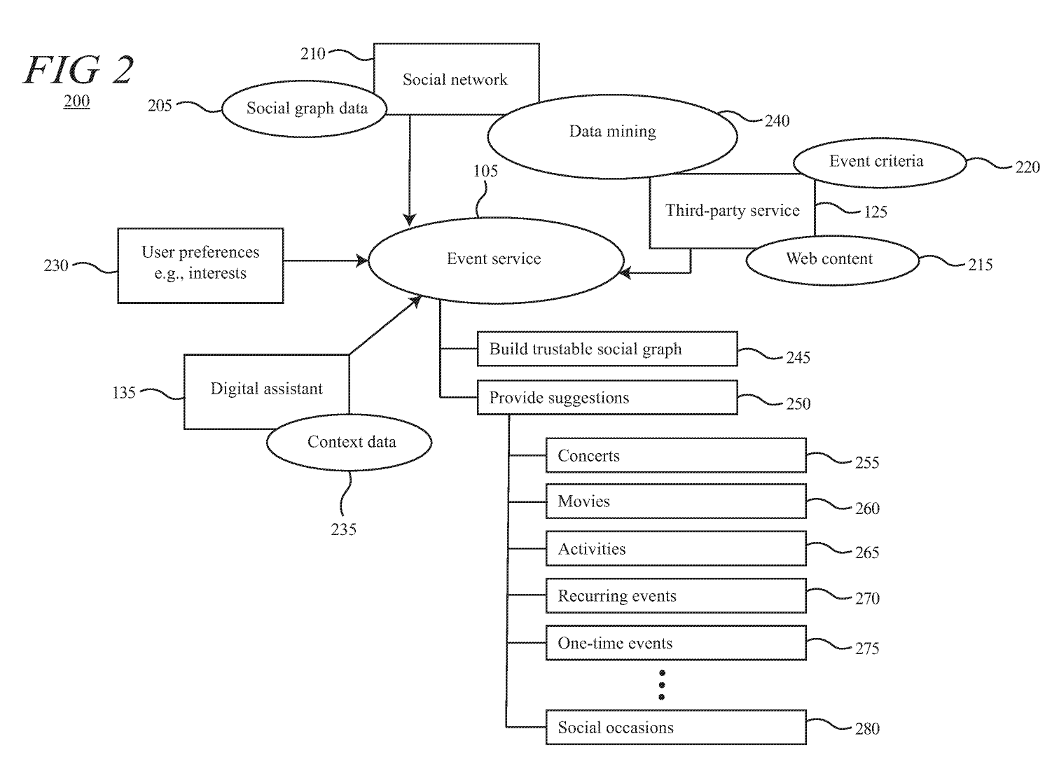

FIG. 2 shows an illustrative environment 200 in which the event service 105 receives multiple inputs from a variety of sources in order to perform various functions. The event service can receive social graph data 205 from social networks 210, web content 215 and event criteria 220 from third-party service 125, user preferences 230 directly from the user, and context data 235 from the digital assistant 135. Alternatively, the user preferences may be identified by the digital assistant and transmitted to the event service with the context data.

The social graph data obtained by the event service may be obtained by various data mining techniques 240 such as social network analysis (SNA) and social media mining, among others (collectively referred to as data mining). The data mining can include, with notice to the user and user consent, intelligently sifting through existing social networks to identify connections, friends, corporate organization charts, school social class systems, hobbyist groups and clubs, etc. Data mining may include data pre-processing, data analysis, and data interpretation processes for proper data analysis. Exemplary social media data mining techniques include hierarchical or point-assignment clustering to groups nodes within a network, and collaborative filtering which isolates associations among users.

The data mining techniques may result in the development of a trustable social graph 245, as shown in FIG. 2. The trustable social graph may be, for example, a relational graph that represents nodes and connections between nodes, in which each node is a particular entity, user, etc. and the connections indicate the relationships. A frequent highly connected or dense subgraph within the relational graph may indicate strong relationships within the social graph. Thus, upon the event service retrieving the social graph data from a variety of sources and executing the data mining techniques, the event service generates a trusted proprietary social graph. Alternatively, however, the event service may utilize the data as retrieved from the respective social network without any modification or creation of a proprietary social graph.

The data retrieved from the third-party service 125 may be associated with any number of organizations or entities. The event service can mine for data on the World Wide Web in order to identify when and what events will take place. This can include text mining web pages for particular information in order to ascertain the presence or occurrence of available activities/events and corresponding descriptive information.

The event service can link with and access information from particular establishments or organizations in order to obtain information. For example, the event service can receive access, with notice to the establishment and their consent, information concerning sporting events (e.g., baseball, football, soccer, and bowling), theatrical plays, comedy shows, musical concerts, and the like. By having direct access to the third-party databases, the event service can easily obtain an accurate and up-to-date list of all relevant information, including the type of event, duration, start time, end time, human occupancy capacity, etc.

As further illustrated in FIG. 2, once the event service has the pertinent information from the variety of sources, the event service 105 can determine and generate event and activity suggestions 250. The activity suggestions can be tailored to the particular user or group of users based on the intelligent analysis and inferences from the collected data. Activities and events suggested by the event service can include, for example, concerts 255, movies 260, activities 265, recurring events 270 (e.g., events/activities that occur regularly), one-time events 275 (e.g., a rare event like a once-a-year charity ball), and social occasions 280 (e.g., meeting friends at a coffee shop).

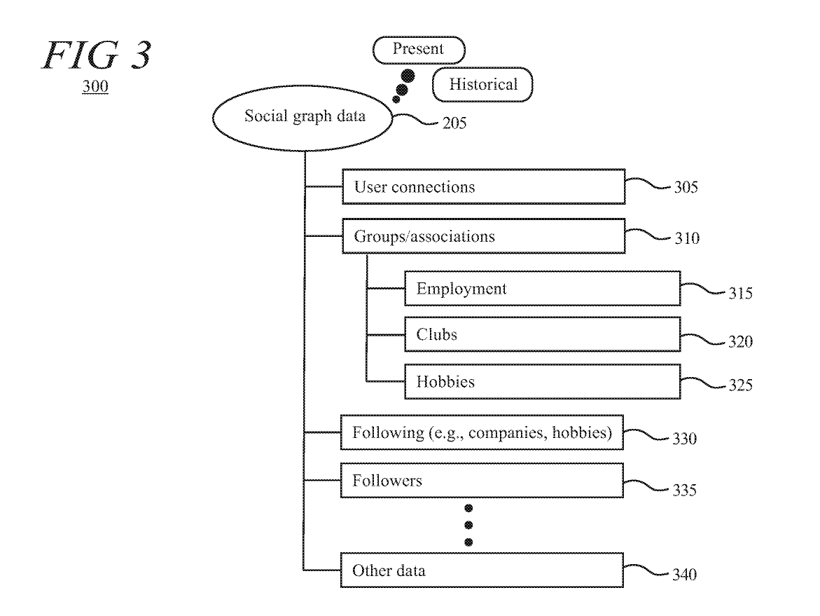

FIG. 3 provides an illustrative taxonomy 300 of social graph data 205 which the event service can obtain from a social network. The event service can use the social graph data to identify groups, associations, and connections among the users as a first step in selecting which users receive activity suggestions. The social graph data may be based on both present connections (e.g., current colleagues) and past connections (e.g., colleagues from a prior job, friends in a past class). In this non-exhaustive and exemplary list, the social graph data can include user connections 305, groups/associations 310, whom the user is following 330, who is following the user 335, and other data 340. The groups/associations 310 element may be even further divided into employment 315, clubs 320, and hobbies 325.

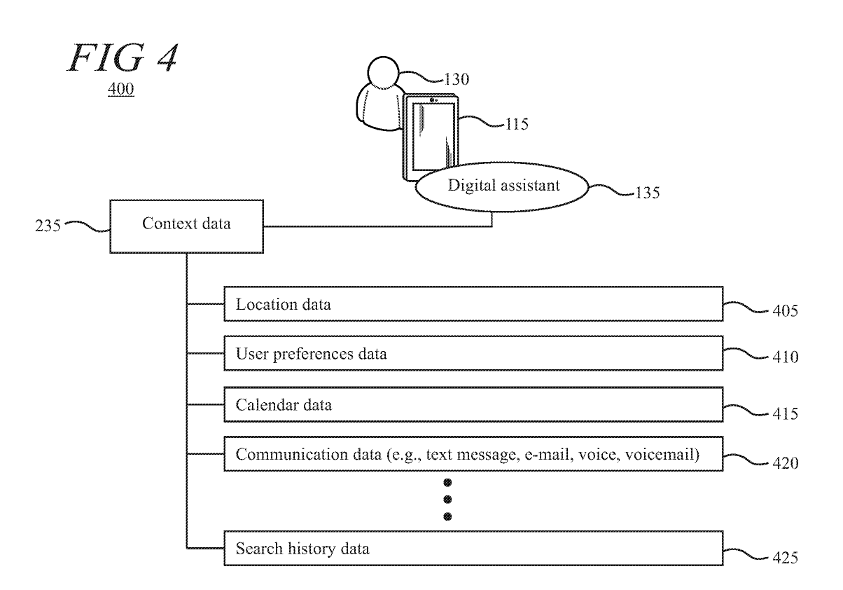

FIG. 4 shows an illustrative taxonomy 400 of context data 235 that may be utilized by the event service as described with respect to FIG. 2. The context data may be monitored and identified by the digital assistant, and then forwarded to the event service. The context data can include, for example, location data 405, user preferences data 410, calendar data 415, communication data (e.g., text message, e-mail, voice, voicemail) 420, and search history data 425.

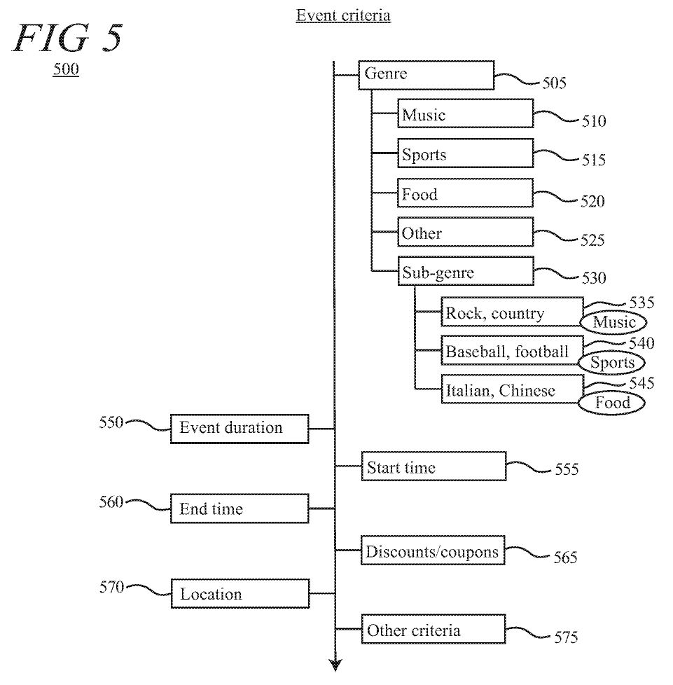

FIG. 5 shows an illustrative taxonomy 500 of items that describe event criteria (e.g., characteristics) about a particular event that allows the event service to properly match events/activities according to an individual's likes, interests, hobbies, etc. For example, the event criteria can include genre 505, event duration 550, start time 555, end time 560, discounts/coupons available 565, location 570, and other criteria 575. As illustrated in FIG. 5, the genre 505 can include music 510, sports 515, food 520, and other 525. Even further, the genre can include a sub-genre section 530 that even further particularizes the groups. For example, the music genre can be further divided into rock and country 535, the sports genre can be further divided into baseball and football 540, and a food genre can be further divided into Italian and Chinese 545. The further specific the genre (or type of event) in which the events/activities are described, the more accurate and fitting the suggestions can be to the user or group of users.

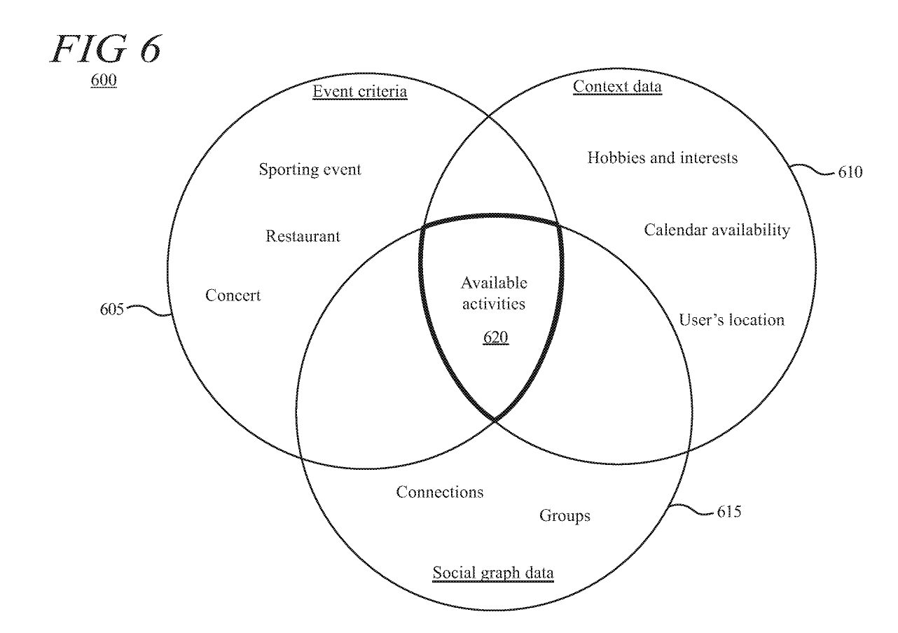

When the event service retrieves all of the relevant data (FIGS. 3-5), the event service can identify available activities for groups of users. FIG. 6 provides a graphical depiction 600 of how the event service can determine available activities/events that are ultimately transmitted and provided to users. The event service is aware of various activities and event criteria 605, context data 610 associated with users, and social graph data 615. Based on the compilation of this data, the event service determines available, suggested, and tailored activities that a group of users can attend when criteria in all three groups 605, 610, and 615 are satisfied and, thus, the groups overlap. Therefore, the available activities 620 takes into consideration users that are connected with each other on a social graph, event criteria, and context data associated with each user.

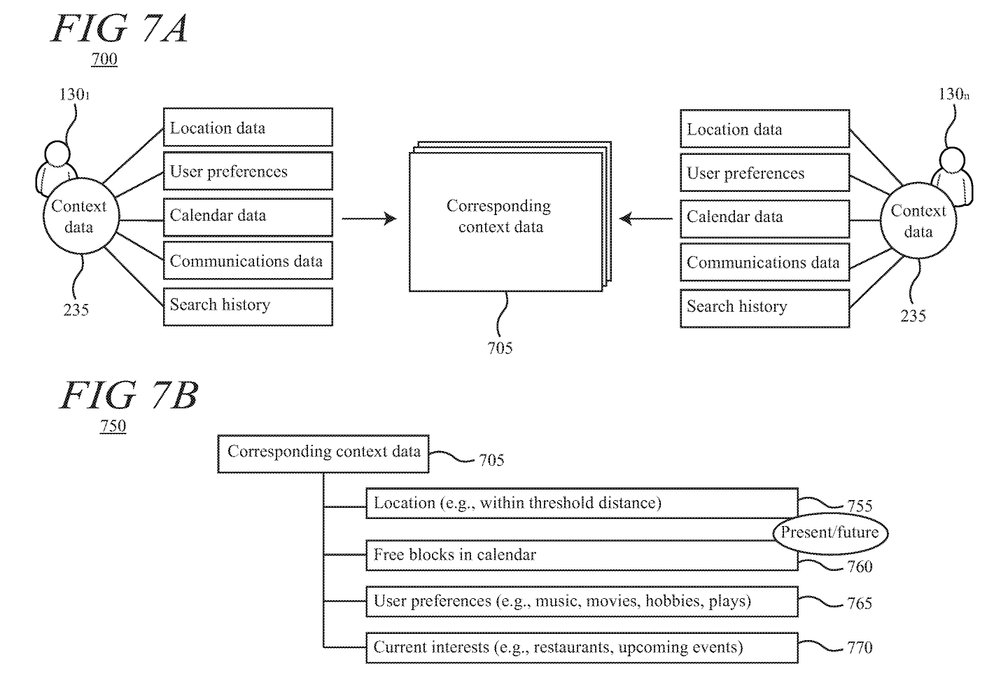

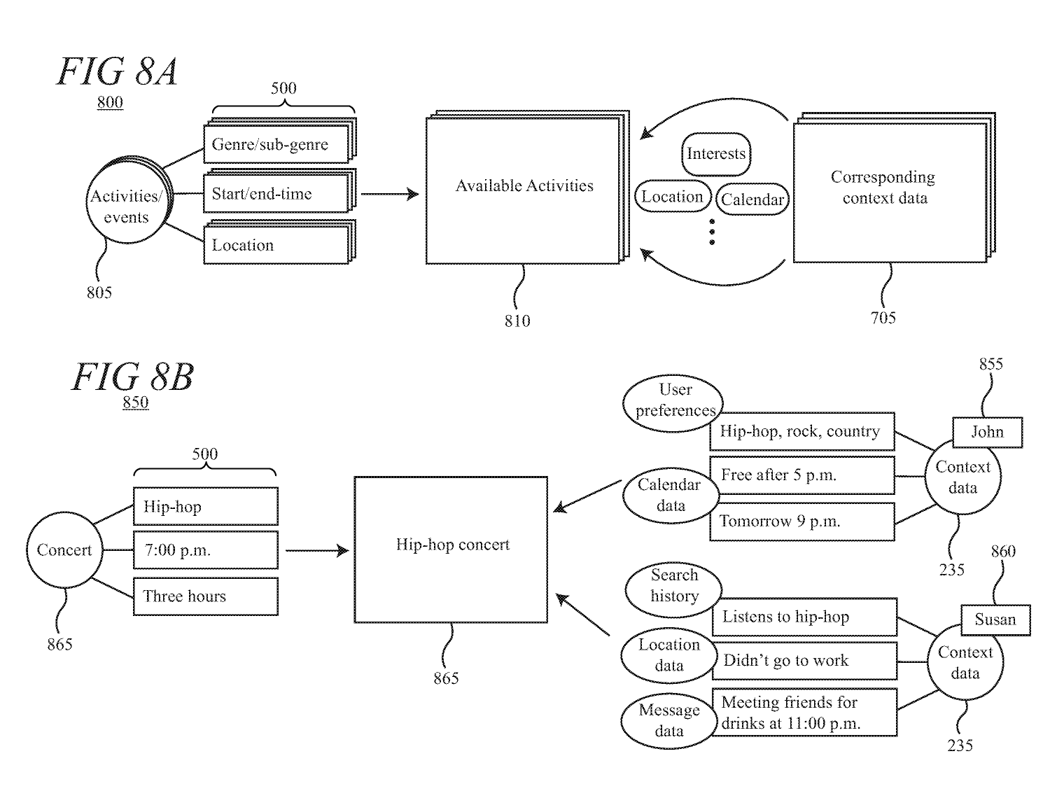

FIG. 7A shows an illustrative environment 700 in which the event service compares context data 235 between two users in order to determine corresponding context data 705 between the users 130. The corresponding context data can include any context data associated with each user that is similar, analogous, or corresponds. Although two users are shown in the FIG. 7A, the event service may compare and determine corresponding context data on any number of users within the same social graph.

FIG. 7B provides a taxonomy 750 of corresponding context data 705 between two or more users (i.e., group), which can include location (e.g., within a threshold distance currently or in the future) 755; free blocks in calendar 760; user preferences (e.g., music, movies, hobbies, plays) 765; and current interests (e.g., restaurants, upcoming events) 770.

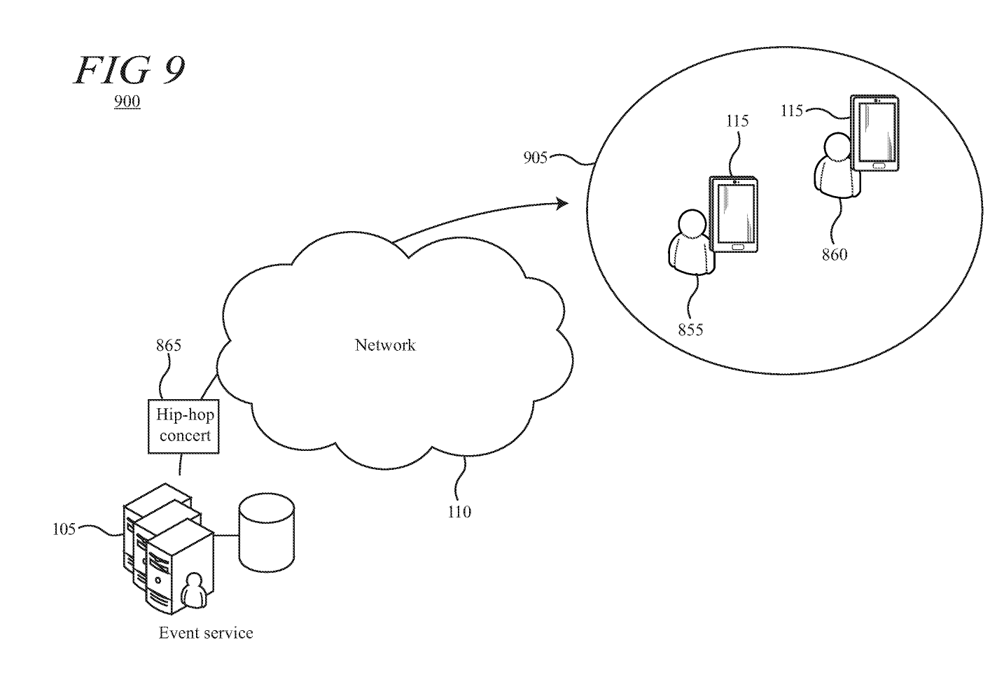

FIG. 8A shows a schematic comparison 800 between the identified corresponding context data 705 and the event criteria 500 associated with one or more activities 805 to determine available activities 810. Each activity 805 can be associated with one or more event criteria that describe the particular event (FIG. 5). Although not shown, the event service receives the event criteria and utilizes the generated corresponding context data to determine the available activities.

FIG. 8B shows an illustrative scenario 850 in which the events, event criteria, and context data are populated with exemplary data for two users John 855 and Susan 860. The event is a concert 865 and the event criteria describe hip-hop music, the start-time of 7:00 p.m., and the duration of the concert being three hours. Comparatively, the context data 235 for John indicates that he likes hip-hop, rock, and country music, is free after 5:00 p.m., and does not have any obligations until the following night at 9:00 p.m. The context data associated with Susan, who is in the same social graph as John, indicates that she listens to hip-hop music, did not go to work today, and is meeting friends at 11:00 p.m. Therefore, because Susan's meeting with friends is not until after the concert ends at 10:00 p.m., the event service determines that Susan is a proper candidate to receive the hip-hop concert as an event suggestion with at least her friend John. In sum, both users' context data satisfied the criteria for the hip-hop concert and therefore the event service identified the hip-hop concert as an available activity for at least both these users.

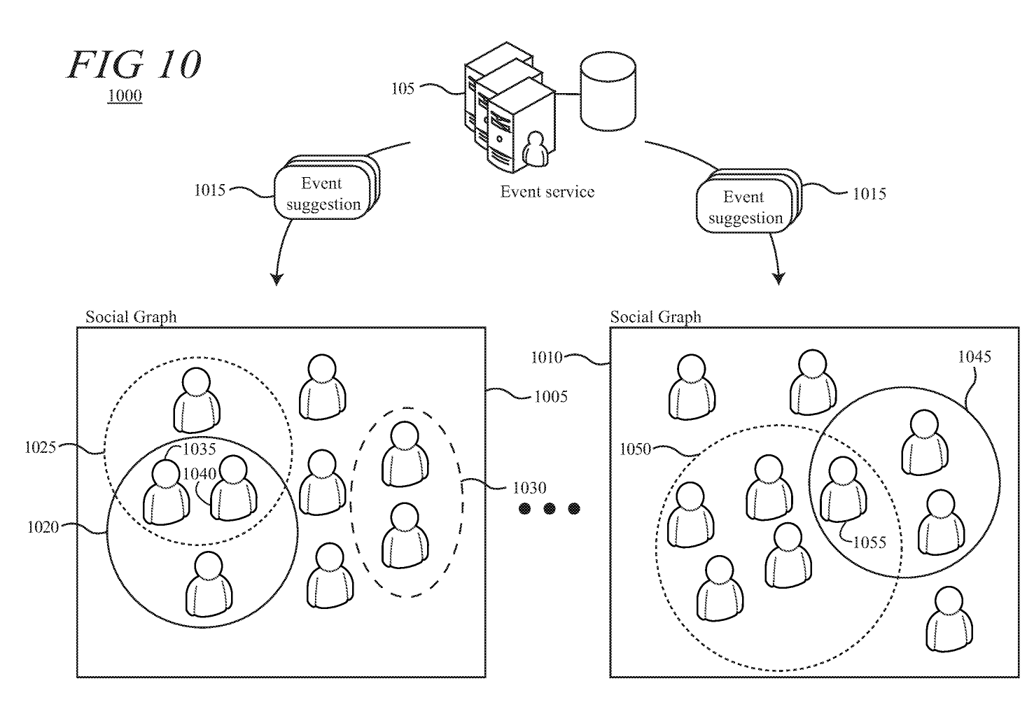

When the comparison identifies multiple users with which the context data satisfies the event criteria, as shown in FIG. 8B, the event service transmits the one or more suggested events to each user within the identified group. FIG. 9 shows an illustrative environment 900 in which the event service 105 transmits the identified available activity (hip-hop concert) over the network to John and Susan (from FIG. 8B). As depicted in FIG. 9, Susan and John are both members of at least one social graph 905. The identified groups can dynamically change based on the scenario, namely the context data, social graph data, and the event criteria data.

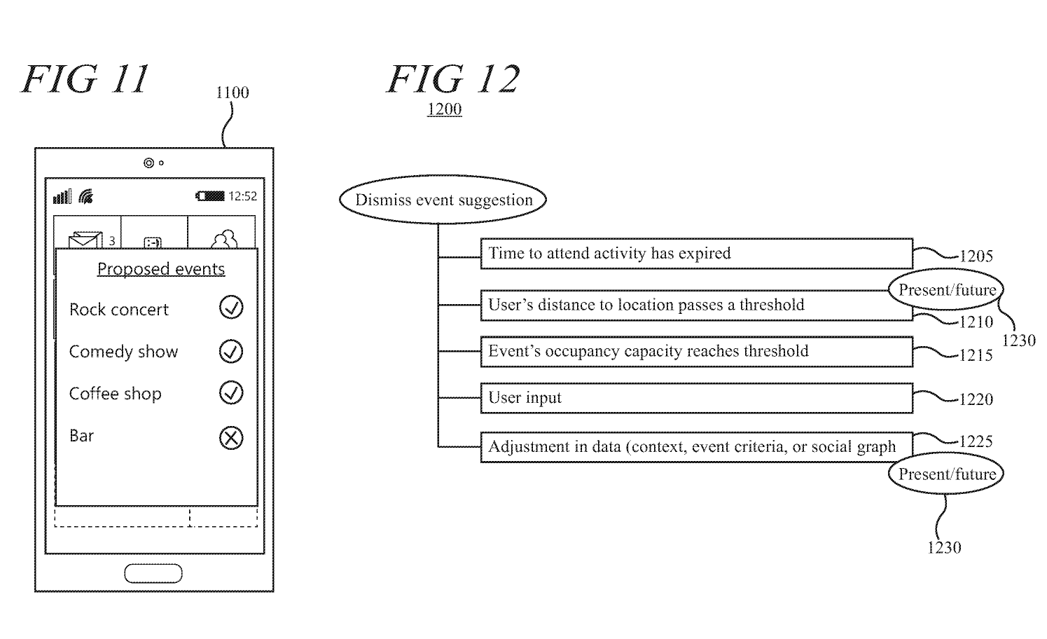

FIG. 10 shows an illustrative environment 1000 in which the event service transmits event suggestions 1015 to various groups' social graphs 1005 and 1010. Each user within the respective social graph may be connected or related to each other by virtue of a class, hobby, team, employment, etc. (FIG. 3). The event service determines activities tailored to the individual groups within the respective social graphs.

Referring first to social graph 1005, each member can be a part of one, none, or multiple groups that the event service identifies based on the scenario. Thus, depending on how many groups with which the event service associates a given user, the user can receive no event suggestions, one event suggestion, or multiple event suggestions at any given time. Social graph 1005 portrays three different identified groups 1020, 1025, and 1030. Members 1035 and 1040 overlap between two different groups 1020 and 1025 within the same social graph. Accordingly, members 1035 and 1040 may receive event suggestions associated with both groups.

In contrast, members within group 1025 may receive one or more event suggestions associated with only that group until one or both members are associated with another group at another point in time. The users that have not been identified in any particular group would not receive any suggestions given the current scenario (e.g., the context data and event criteria).

Similarly, social graph 1010 includes two groups 1045 and 1050 which the event service has identified and has determined activities for. In this scenario, member 1055 in the social graph is associated with both groups, and therefore may receive the one or more event suggestions associated with both groups. In contrast, the other members who are part of only one group may receive event suggestions associated with the single group with which they are associated. Members not part of any group may not receive an event suggestion until the event service incorporates or includes the members into a group based on the ever-changing context data, social graph data, and event criteria data.

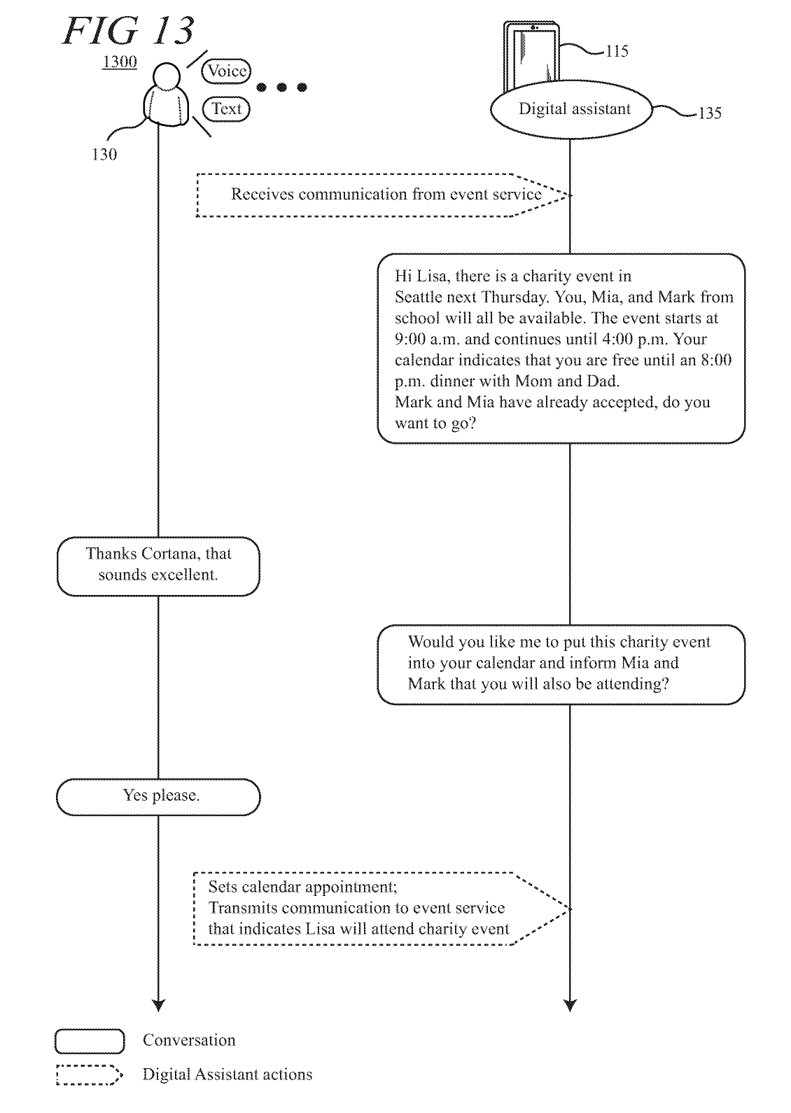

FIG. 11 provides an illustrative display 1100 in which the user can select which suggested events he wishes to, or not, attend. In this example, the event service provided the user with four different events, including a rock concert, a comedy show, a coffee shop, and a bar. As illustrated in FIG. 11, the user accepted the rock concert, comedy show, and coffee shop, and rejected the bar suggestion. Although not shown, the user may select any activity to identify additional information, such as who is in the group, the location of the event, time of the event, etc.

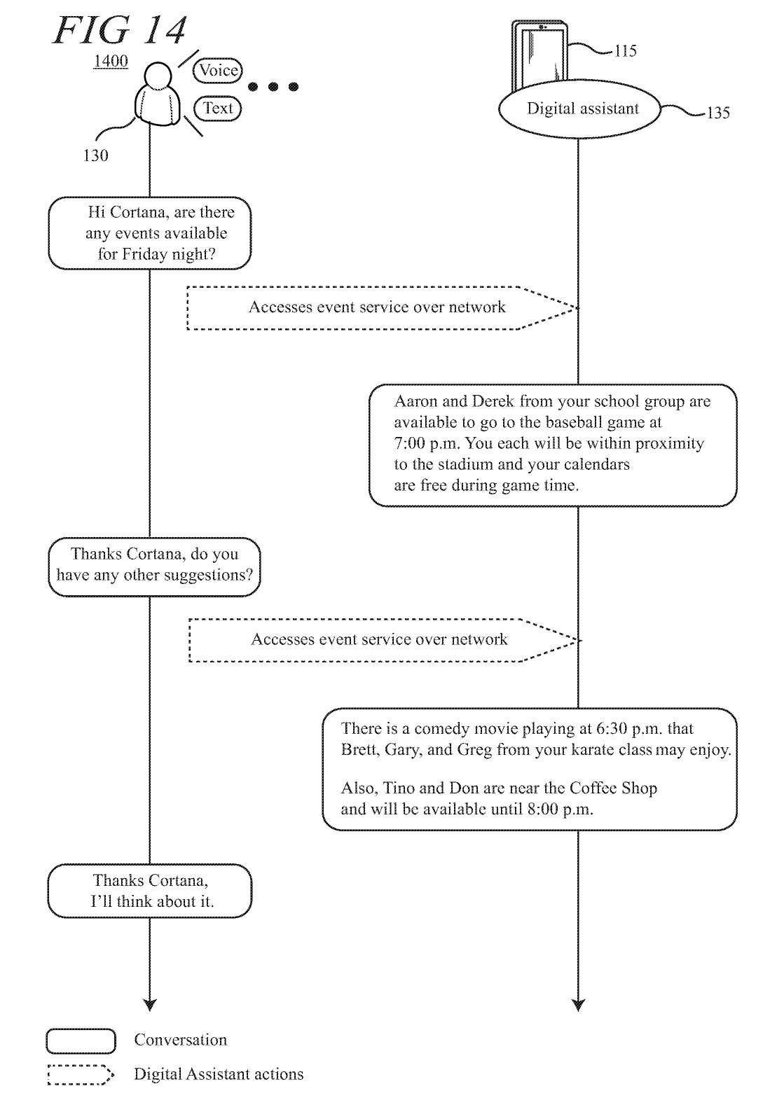

FIG. 12 provides an illustrative taxonomy 1200 of occurrences that cause the event service to dismiss the transmitted event suggestion. For example, the service may dismiss the event suggestion when the time to attend the activity has expired 1205; the user's distance to the location passes a threshold 1210; the event's occupancy capacity reaches a threshold 1215; user input 1220 (e.g., reject event); or an adjustment in data (e.g., a change in context data, event criteria, or social graph data) 1225. The various items may be based on current data or predicted future data 1230. For example, the future context data can change if the user changes an appointment in a calendar which places the user at a different location. Any one or a combination of the provided occurrences may result in dismissal of the transmitted event suggestion.

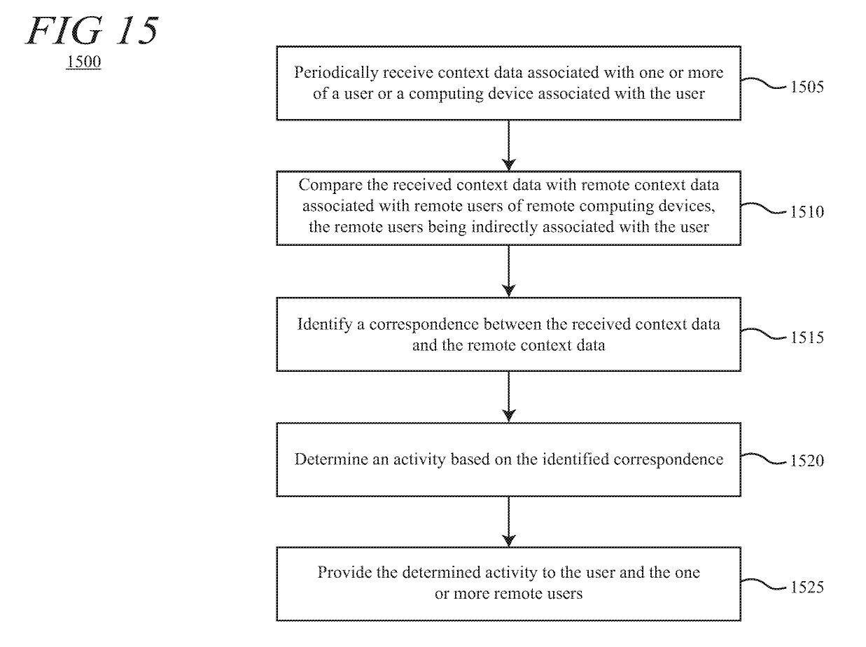

FIG. 13 shows an illustrative interaction 1300 between the user and digital assistant that is proactively initiated by the event service. In this scenario, the event service proactively determined an activity for the user, Lisa, and proactively communicated the event to the user's digital assistant. The digital assistant proposes a charity event, details about the charity event, and other users who were identified to accompany Lisa to the charity event. The digital assistant then communicates Lisa's acceptance to the charity event to the event service and sets the appointment in Lisa's calendar.

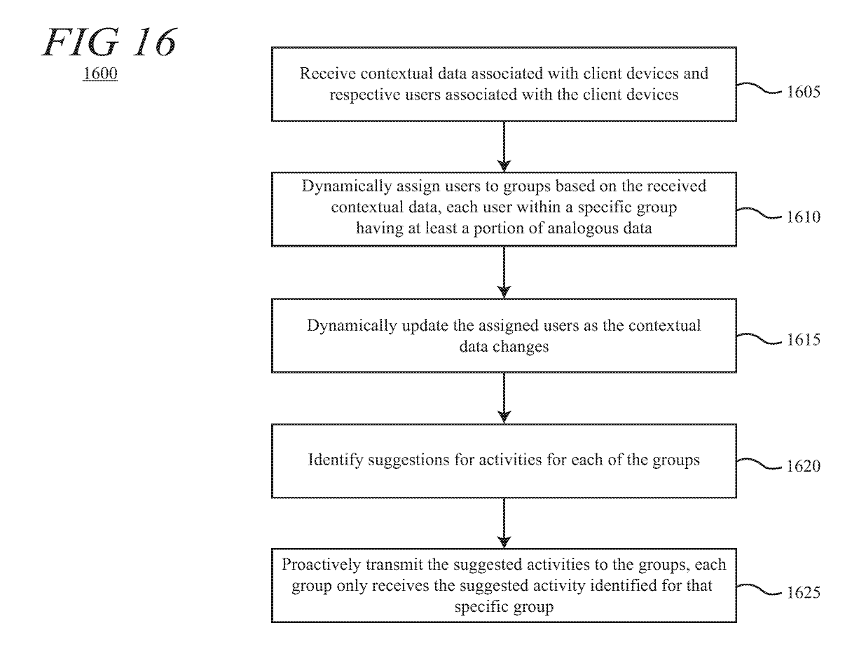

FIG. 14 shows an illustrative interaction 1400 between the user and digital assistant that is reactive to the user's inquiry. In this scenario the user asks the digital assistant for available events on Friday night. The digital assistant accesses the event service and provides the user with a suggestion to attend a baseball game at 7:00 p.m. with his friends Aaron and Derek from his school group. The event service identified that the three friends will be within a threshold proximity to the stadium and that their calendars are free during game time. Although the digital assistant provides the user with the suggestion, the digital assistant interoperates with the event service by submitting a query to the event service for available events on Friday night. Therefore, instead of proactively providing the user with suggested events/activities, the event service reactively provided the suggestion in this example.

The user subsequently asks the digital assistant for another suggestion, in which the digital assistant again queries the event service. The event service again identifies members within the user's social graph, context data, and event criteria data to determine other available activities for the user. The event service determines two more potential activities for the user: to see a comedy movie with one group of friends or go to a coffee shop with a separate group.

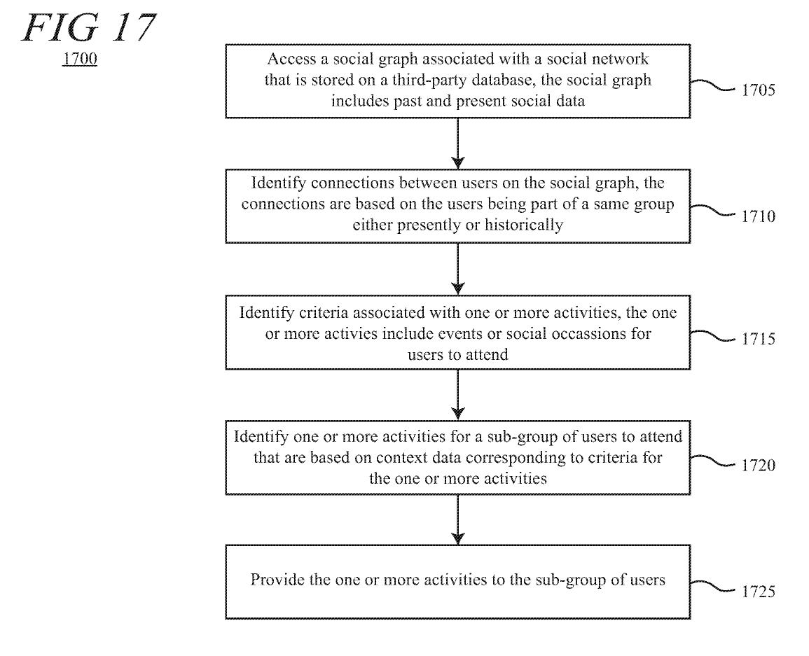

FIG. 15 is a flowchart of an illustrative method 1500 to determine an activity based on context data and provide the determined activity to a user and one or more remote users. Unless specifically stated, methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 1505, context data associated with one or more of a user or a computing device associated with the user is periodically received. In step 1510, the received context data is compared with remote context data. The remote context data may include, for example, context data associated with a remote user and a remote computing device associated with the remote user. In step 1515, a correspondence between the received context data and the remote context data is identified. In step 1520, an activity based on the identified correspondence is determined. In step 1525, the determined activity is provided to the user and the one or more remote users.

FIG. 16 is a flowchart of an illustrative method 1600 that may be performed by an event service. In step 1605, contextual data associated with client devices and respective users of the client devices is received. In step 1610, users are dynamically assigned to groups based on the received contextual data. Each user within a specific group have at least a portion of analogous context data. In step 1615, the assignment of users to groups is dynamically updated as the contextual data changes. In step 1620, suggestions for activities are identified for each of the groups. In step 1625, the suggested activities are proactively transmitted to the groups. In this example, each group may only receive the suggested activity identified for that specific group.

FIG. 17 is a flowchart of an illustrative method 1700 that may be performed by a computing device, such as a server. In step 1705, a social graph associated with a social network is accessed. The social graph may be associated with a third-party database, and the social graph can include past and present social data. In step 1710, connections between users on the social graph are identified. The connections can be based on the users being part of a same group on the social graph either presently or historically. In step 1715, criteria associated with one or more activities are identified. The one or more activities can include events or social occasions for users to attend. In step 1720, one or more activities for a sub-group of users to attend are identified. The identified activities are based on context data corresponding to criteria for the one or more activities. Finally, in step 1725 the one or more activities are provided to the sub-group of users.

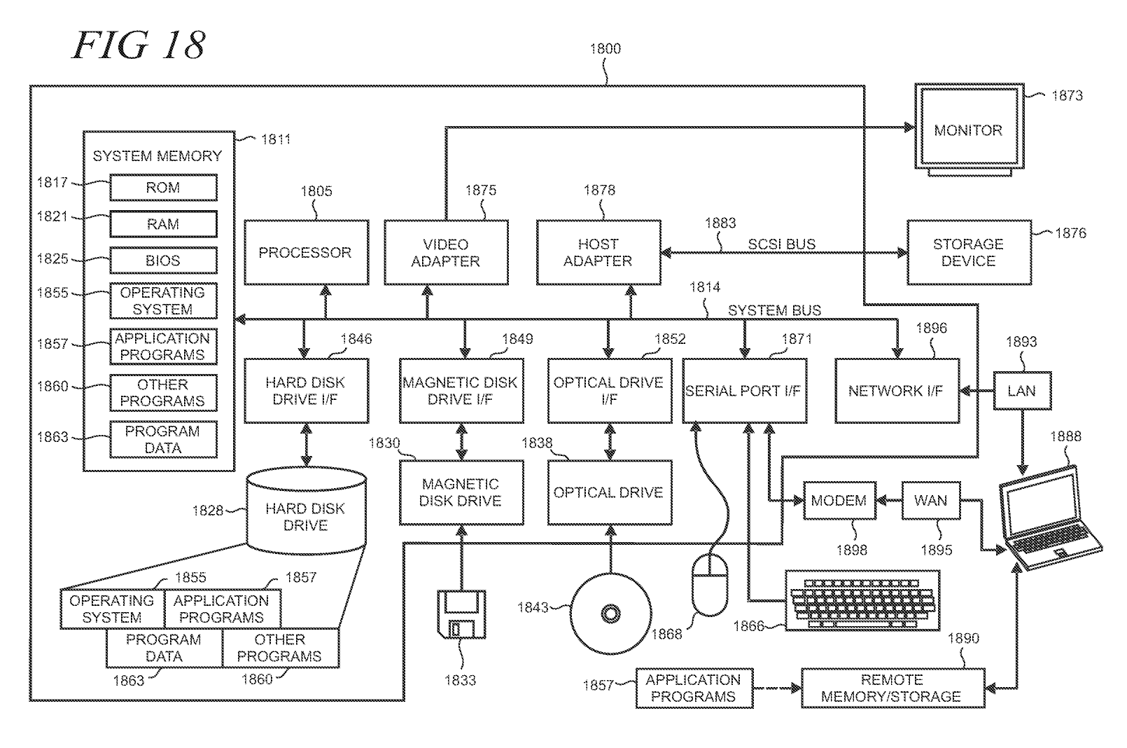

FIG. 18 is a simplified block diagram of an illustrative computer system 1800 such as a PC, client machine, or server with which the present auto-suggestion for group activities based on combined data sets can be implemented. Computer system 1800 includes a processor 1805, a system memory 1811, and a system bus 1814 that couples various system components including the system memory 1811 to the processor 1805. The system bus 1814 may be any of several types of bus structures including a memory bus or memory controller, a peripheral bus, or a local bus using any of a variety of bus architectures. The system memory 1811 includes read only memory (ROM) 1817 and random access memory (RAM) 1821. A basic input/output system (BIOS) 1825, containing the basic routines that help to transfer information between elements within the computer system 1800, such as during startup, is stored in ROM 1817. The computer system 1800 may further include a hard disk drive 1828 for reading from and writing to an internally disposed hard disk (not shown), a magnetic disk drive 1830 for reading from or writing to a removable magnetic disk 1833 (e.g., a floppy disk), and an optical disk drive 1838 for reading from or writing to a removable optical disk 1843 such as a CD (compact disc), DVD (digital versatile disc), or other optical media. The hard disk drive 1828, magnetic disk drive 1830, and optical disk drive 1838 are connected to the system bus 1814 by a hard disk drive interface 1846, a magnetic disk drive interface 1849, and an optical drive interface 1852, respectively. The drives and their associated computer-readable storage media provide non-volatile storage of computer-readable instructions, data structures, program modules, and other data for the computer system 1800. Although this illustrative example includes a hard disk, a removable magnetic disk 1833, and a removable optical disk 1843, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present auto-suggestion for group activities based on combined data sets. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk drive 1828, magnetic disk drive 1830, optical disk drive 1838, ROM 1817, or RAM 1821, including an operating system 1855, one or more application programs 1857, other program modules 1860, and program data 1863. A user may enter commands and information into the computer system 1800 through input devices such as a keyboard 1866 and pointing device 1868 such as a mouse. Other input devices (not shown) may include a microphone, joystick, game pad, satellite dish, scanner, trackball, touchpad, touchscreen, touch-sensitive device, voice-command module or device, user motion or user gesture capture device, or the like. These and other input devices are often connected to the processor 1805 through a serial port interface 1871 that is coupled to the system bus 1814, but may be connected by other interfaces, such as a parallel port, game port, or universal serial bus (USB). A monitor 1873 or other type of display device is also connected to the system bus 1814 via an interface, such as a video adapter 1875. In addition to the monitor 1873, personal computers typically include other peripheral output devices (not shown), such as speakers and printers. The illustrative example shown in FIG. 18 also includes a host adapter 1878, a Small Computer System Interface (SCSI) bus 1883, and an external storage device 1876 connected to the SCSI bus 1883.

The computer system 1800 is operable in a networked environment using logical connections to one or more remote computers, such as a remote computer 1888. The remote computer 1888 may be selected as another personal computer, a server, a router, a network PC, a peer device, or other common network node, and typically includes many or all of the elements described above relative to the computer system 1800, although only a single representative remote memory/storage device 1890 is shown in FIG. 18. The logical connections depicted in FIG. 18 include a local area network (LAN) 1893 and a wide area network (WAN) 1895. Such networking environments are often deployed, for example, in offices, enterprise-wide computer networks, intranets, and the Internet.

When used in a LAN networking environment, the computer system 1800 is connected to the local area network 1893 through a network interface or adapter 1896. When used in a WAN networking environment, the computer system 1800 typically includes a broadband modem 1898, network gateway, or other means for establishing communications over the wide area network 1895, such as the Internet. The broadband modem 1898, which may be internal or external, is connected to the system bus 1814 via a serial port interface 1871. In a networked environment, program modules related to the computer system 1800, or portions thereof, may be stored in the remote memory storage device 1890. It is noted that the network connections shown in FIG. 18 are illustrative and other means of establishing a communications link between the computers may be used depending on the specific requirements of an application of the present auto-suggestion for group activities based on combined data sets.

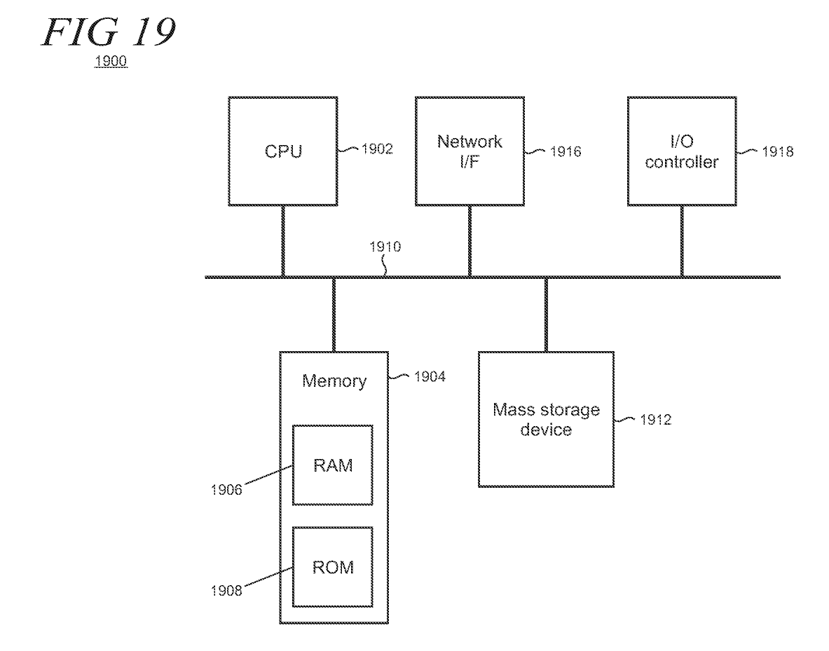

FIG. 19 shows an illustrative architecture 1900 for a device capable of executing the various components described herein for providing an auto-suggestion for group activities based on combined data sets. Thus, the architecture 1900 illustrated in FIG. 19 shows an architecture that may be adapted for a server computer, mobile phone, a PDA, a smartphone, a desktop computer, a netbook computer, a tablet computer, GPS device, game console, and/or a laptop computer. The architecture 1900 may be utilized to execute any aspect of the components presented herein. The architecture 1900 depicted in FIG. 19 may be utilized to implement the devices 115 and 215 (FIGS. 1-2) and the computer system 1800 depicted in FIG. 18 may be utilized on the application servers 365 to implement the automated registration service 405 (FIG. 4).

The architecture 1900 illustrated in FIG. 19 includes a CPU (Central Processing Unit) 1902, a system memory 1904, including a RAM 1906 and a ROM 1908, and a system bus 1910 that couples the memory 1904 to the CPU 1902. A basic input/output system containing the basic routines that help to transfer information between elements within the architecture 1900, such as during startup, is stored in the ROM 1908. The architecture 1900 further includes a mass storage device 1912 for storing software code or other computer-executed code that is utilized to implement applications, the file system, and the operating system.

The mass storage device 1912 is connected to the CPU 1902 through a mass storage controller (not shown) connected to the bus 1910. The mass storage device 1912 and its associated computer-readable storage media provide non-volatile storage for the architecture 1900.

Although the description of computer-readable storage media contained herein refers to a mass storage device, such as a hard disk or CD-ROM drive, it may be appreciated by those skilled in the art that computer-readable storage media can be any available storage media that can be accessed by the architecture 1900.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1900.

According to various embodiments, the architecture 1900 may operate in a networked environment using logical connections to remote computers through a network. The architecture 1900 may connect to the network through a network interface unit 1916 connected to the bus 1910. It may be appreciated that the network interface unit 1916 also may be utilized to connect to other types of networks and remote computer systems. The architecture 1900 also may include an input/output controller 1918 for receiving and processing input from a number of other devices, including a keyboard, mouse, or electronic stylus (not shown in FIG. 19). Similarly, the input/output controller 1918 may provide output to a display screen, a printer, or other type of output device (also not shown in FIG. 19).

It may be appreciated that the software components described herein may, when loaded into the CPU 1902 and executed, transform the CPU 1902 and the overall architecture 1900 from a general-purpose computing system into a special-purpose computing system customized to facilitate the functionality presented herein. The CPU 1902 may be constructed from any number of transistors or other discrete circuit elements, which may individually or collectively assume any number of states. More specifically, the CPU 1902 may operate as a finite-state machine, in response to executable instructions contained within the software modules disclosed herein. These computer-executable instructions may transform the CPU 1902 by specifying how the CPU 1902 transitions between states, thereby transforming the transistors or other discrete hardware elements constituting the CPU 1902.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1900 in order to store and execute the software components presented herein. It also may be appreciated that the architecture 1900 may include other types of computing devices, including handheld computers, embedded computer systems, smartphones, PDAs, and other types of computing devices known to those skilled in the art. It is also contemplated that the architecture 1900 may not include all of the components shown in FIG. 19, may include other components that are not explicitly shown in FIG. 19, or may utilize an architecture completely different from that shown in FIG. 19.

Various exemplary embodiments of the present auto-suggestion for group activities based on combined data sets are now presented by way of illustration and not as an exhaustive list of all embodiments. An example includes a method performed on a control server that is in communication with a plurality of computing devices over a network, the method comprising: periodically receiving context data associated with one or more of a user or a computing device associated with the user; comparing the received context data with remote context data associated with one or more remote users respectively operating remote devices, the one or more remote users being at least indirectly associated with the user; identifying a correspondence between the received context data and the remote context data; determining an activity based on the identified correspondence; providing the determined activity to the user and the one or more remote users.

In another example, connections within a social graph are used to determine whether the user and the one or more remote users are indirectly associated with each other. In another example, the method further includes: implementing data mining techniques to retrieve social graph data from one or more social networks; building a trustable social graph with the social graph data; and determining whether the user and the one or more remote users are indirectly associated with each other using the trustable social graph. In another example, the context data and the remote context data include one or more of location data, user preferences data, calendar data, communication data, or search history data. In another example, the method further includes receiving from the user and the one or more remote users a confirmation or denial to the provided determined activity. In another example, the method further includes: remain pending the provided activity so long as respective user has not denied the activity; and when the activity expires, dismiss the provided activity. In another example, expiration of the activity includes one or more of a time to attend the activity has expired, a user's distance to the activity passes a threshold, occupancy at the activity has reached a threshold, user input, or adjustment to the context data, social graph, or event criteria. In another example, a suggested activity is reactively determined and provided to the user in response to a query for an available activity from the user.

A further example includes a control server, comprising: one or more processors; network connectivity capabilities to communicate with remote databases and client devices over a network; and one or more hardware-based memory devices operatively coupled to the one or more processors and storing instructions which, when executed by the one or more processors cause the control server to: receive contextual data associated with the client devices and respective users associated with each of the client devices, dynamically assign users to groups based on the received contextual data, wherein each user associated with a specific group has at least a portion of analogous context data, dynamically update the assigned users as the context data changes; identify suggestions for activities for each of the groups, and proactively transmit the suggested activities to the groups, wherein each group only receives the suggested activity identified for the specific group.

In another example, the activities are determined based on the analogous context data among the users satisfying event criteria associated with each of the suggested activities. In another example, the event criteria include one or more of genre, sub-genre, duration, start time, end time, available discounts, or location. In another example, the analogous context data satisfies the genre and sub-genre of the event criteria, wherein the sub-genre is a related sub-category within the genre. In another example, a user is assigned to more than one group. In another example, a group receives more than one suggested activity. In another example, the one or more processors further cause the control server to: identify connections between users within a social graph; and only assign users to like-groups if the users share a connection on the social graph. In another example, the social graph is located on a remote database that is accessible by the control server.

A further example includes one or more hardware-based computer-readable memory devices storing instructions which, when executed by one or more processors disposed in a computing device, cause the computing device to: access a social graph associated with a social network that is stored on a third-party database, wherein the social graph includes past and present social data; identify connections between users on the social graph, wherein the connections are based on the users being part of a same group either presently or historically; identify criteria associated with one or more activities, wherein the one or more activities include events or social occasions for users to attend; identify one or more activities to attend for a sub-group of users from the users, wherein the identified activities are based on each member of the sub-group of users being associated with context data that corresponds to criteria for the one or more activities; and provide the one or more activities to the sub-group of users.

In another example, the criteria include one or more of genre of activity, time of activity, length of activity, location of activity, or available openings at the activity. In another example, a same element of the context data for each member of the sub-group of users corresponds to at least one of the criteria. In another example, the one or more activities include concerts, movies, recurring events, one-time events, or social occasions.

Based on the foregoing, it may be appreciated that technologies for auto-suggestion for group activities based on combined user data sets have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and is not to be construed as limiting. Various modifications and changes may be made to the subject matter described herein without following the example embodiments and applications illustrated and described, and without departing from the true spirit and scope of the present invention, which is set forth in the following claims.

What is claimed:

1. A method performed on a control server that is in communication with a plurality of computing devices over a network, the method comprising:
periodically receiving context data associated with one or more of a user or a computing device associated with the user;
comparing the received context data with remote context data associated with one or more remote users respectively operating remote devices, the one or more remote users being at least indirectly associated with the user;
identifying a correspondence between the received context data and the remote context data;
determining an activity based on the identified correspondence;
providing the determined activity to the user and the one or more remote users.

2. The method of claim 1 in which connections within a social graph are used to determine whether the user and the one or more remote users are indirectly associated with each other.

3. The method of claim 1, further including:
implementing data mining techniques to retrieve social graph data from one or more social networks;
building a trustable social graph with the social graph data; and
determining whether the user and the one or more remote users are indirectly associated with each other using the trustable social graph.

4. The method of claim 1 in which the context data and the remote context data include one or more of location data, user preferences data, calendar data, communication data, or search history data.

5. The method of claim 1 further including receiving from the user and the one or more remote users a confirmation or denial to the provided determined activity.

6. The method of claim 1 further including:
remain pending the provided activity so long as respective user has not denied the activity; and
when the activity expires, dismiss the provided activity.

7. The method of claim 6 in which expiration of the activity includes one or more of a time to attend the activity has expired, a user's distance to the activity passes a threshold, occupancy at the activity has reached a threshold, user input, or adjustment to the context data, social graph, or event criteria.

8. The method of claim 1 wherein a suggested activity is reactively determined and provided to the user in response to a query for an available activity from the user.

9. A control server, comprising:
one or more processors;
network connectivity capabilities to communicate with remote databases and client devices over a network; and
one or more hardware-based memory devices operatively coupled to the one or more processors and storing instructions which, when executed by the one or more processors cause the control server to:
receive contextual data associated with the client devices and respective users associated with each of the client devices,
dynamically assign users to groups based on the received contextual data, wherein each user associated with a specific group has at least a portion of analogous context data,
dynamically update the assigned users as the context data changes;
identify suggestions for activities for each of the groups, and
proactively transmit the suggested activities to the groups, wherein each group only receives the suggested activity identified for the specific group.

10. The control server of claim 9 in which the activities are determined based on the analogous context data among the users satisfying event criteria associated with each of the suggested activities.

11. The control server of claim 10 in which the event criteria include one or more of genre, sub-genre, duration, start time, end time, available discounts, or location.

12. The control server of claim 11 in which the analogous context data satisfies the genre and sub-genre of the event criteria, wherein the sub-genre is a related sub-category within the genre.

13. The control server of claim 9 in which a user is assigned to more than one group.

14. The control server of claim 9 in which a group receives more than one suggested activity.

15. The control server of claim 9 in which the one or more processors further cause the control server to:
identify connections between users within a social graph; and
only assign users to like-groups if the users share a connection on the social graph.

16. The control server of claim 15 in which the social graph is located on a remote database that is accessible by the control server.

17. One or more hardware-based computer-readable memory devices storing instructions which, when executed by one or more processors disposed in a computing device, cause the computing device to:
access a social graph associated with a social network that is stored on a third-party database, wherein the social graph includes past and present social data;
identify connections between users on the social graph, wherein the connections are based on the users being part of a same group either presently or historically;
identify criteria associated with one or more activities, wherein the one or more activities include events or social occasions for users to attend;
identify one or more activities to attend for a sub-group of users from the users, wherein the identified activities are based on each member of the sub-group of users being associated with context data that corresponds to criteria for the one or more activities; and
provide the one or more activities to the sub-group of users.

18. The one or more hardware-based computer-readable memory devices of claim 17, in which the criteria include one or more of genre of activity, time of activity, length of activity, location of activity, or available openings at the activity.

19. The one or more hardware-based computer-readable memory devices of claim 18, in which a same element of the context data for each member of the sub-group of users corresponds to at least one of the criteria.

20. The one or more hardware-based computer-readable memory devices of claim 19, in which the one or more activities include concerts, movies, recurring events, one-time events, or social occasions.
